(19) United States
(12) Patent Application Publication
(10) Pub. No.: US 2018/0071753 A1
(43) Pub. Date: Mar. 15, 2018

(54) CENTRIFUGE HAVING ONBOARD IMAGING SYSTEM

(71) Applicant: WEATHERFORD TECHNOLOGY HOLDINGS, LLC, Houston, TX (US)

(72) Inventors: Sean M. CHRISTIAN, Sparrows Point, MD (US); Daniel Charles BOYDE, Tiverton (GB); Luis Schwartz CARRASQUERO, Pearland, TX (US); Dan N. M. HOANG, Houston, TX (US)

(21) Appl. No.: 15/563,295

(22) PCT Filed: Mar. 30, 2016
(86) PCT No.: PCT/US2016/024972

§ 371 Date: Sep. 29, 2017

Related U.S. Application Data
(60) Provisional application No. 62/141,376, filed on Apr. 1, 2015.

(51) Int. Cl. B04B 5/10; G01N 15/04; H04N 1/00; H02K 7/08; G02B 5/08; H02J 50/10; H02K 7/14; B01F 11/00; G01N 15/14; H01Q 1/22

(52) U.S. Cl. CPC B04B 5/10; G01N 15/042; H04N 1/00204; H02K 7/088; H01Q 1/22; H02J 50/10; H02K 7/14; B01F 11/0017; G01N 15/1436; G02B 5/08

(57) ABSTRACT

A centrifuge (1) includes: a motor (4) having a rotor (3); an imaging system (2) torsionally connected to the rotor; a sample holder torsionally connected to the imaging system; and a light source for illuminating the sample holder. The imaging system (2) includes: a image sensor in optical communication with the sample holder; and a data link for transmitting image data. A centrifuge test includes: spinning a reservoir core sample in a sample holder of a rotor, wherein an imaging system is torsionally connected to the rotor; and collecting image data of the sample holder with the imaging system while spinning.

### BACKGROUND OF THE DISCLOSURE

### Field of the Disclosure

The present disclosure generally relates to a centrifuge having an onboard imaging system.

### Description of the Related Art

The oil industry utilizes centrifuges for measuring static and dynamic fluid and/or rock properties of reservoir core samples. These properties are important for describing the flow of fluids in porous media and are generally needed in the reservoir engineering of an oilfield. These properties help the reservoir engineer determine, for example, the productivity of a reservoir, the total reserves, and the likelihood of success for various oil recovery processes, such as water flooding or carbon dioxide flooding.

For a centrifuge test, the core samples are mounted in special holders having collection tubes to allow for monitoring the production of fluid from the core samples. The cores are spun using the centrifuge, and the effluent fluids from the samples are collected in the tubes. An external strobe light and external camera are used to determine the amounts of fluids collecting in the collection tubes.

Current centrifuge imaging systems for capillary pressure and relative permeability tests are stationary relative to the spinning rotor of the centrifuge. With centrifuge speeds that may exceed fifteen thousand revolutions per minute, an extremely high-speed imaging system is required. The use of stationary imaging systems requires accurate synchronization of the imaging system with the centrifuge and severely limits the ultimate accuracy of the test due to poor contrast ratios, image blur, and frame-to-frame offset.

### SUMMARY OF THE DISCLOSURE

The present disclosure generally relates to a centrifuge having an onboard imaging system. In one embodiment, a centrifuge includes: a motor having a rotor; an imaging system torsionally connected to the rotor; a sample holder torsionally connected to the imaging system; and a light source for illuminating the sample holder. The imaging system includes: a image sensor in optical communication with the sample holder; and a data link for transmitting image data. In one embodiment, conducting a centrifuge test includes: spinning a reservoir core sample in a sample holder of a rotor, wherein an imaging system is torsionally connected to the rotor; and collecting image data of the sample holder with the imaging system while spinning.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1 and 4B illustrate a drainage test being performed using a centrifuge having an onboard imaging system, according to one embodiment of the present disclosure.

FIGS. 2, 3, and 4A illustrate the centrifuge.

FIG. 5 illustrates an alternative imaging system having a battery instead of a wireless power coupling, according to another embodiment of the present disclosure.

FIG. 6 illustrates an alternative centrifuge for performing an imbibition test, according to another embodiment of the present disclosure.

FIG. 7 illustrates a second alternative centrifuge, according to another embodiment of the present disclosure.

### DETAILED DESCRIPTION

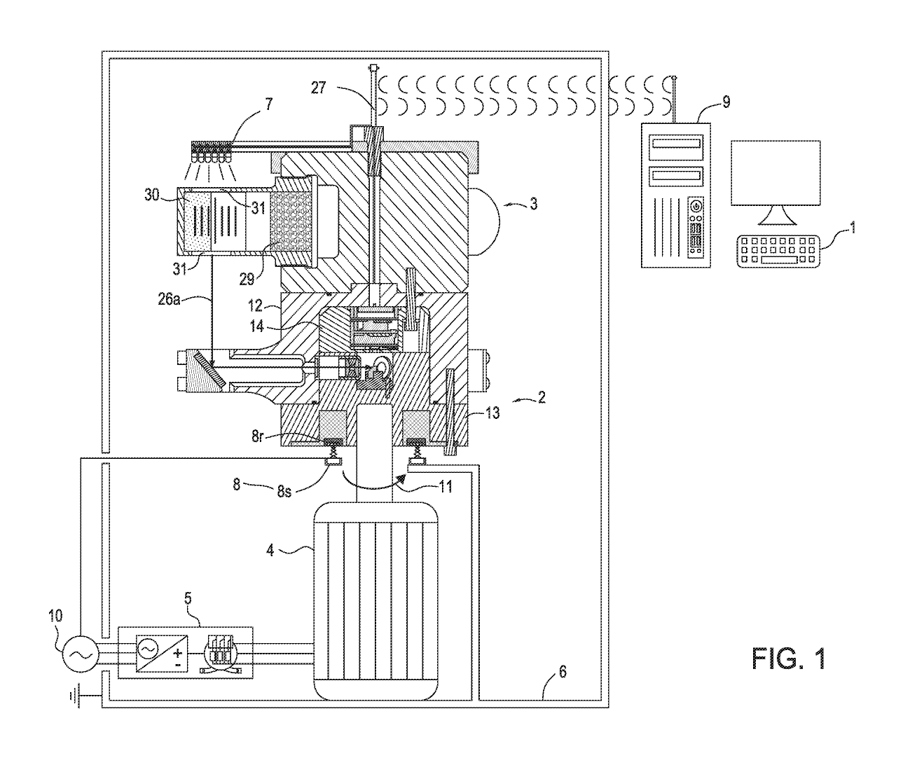

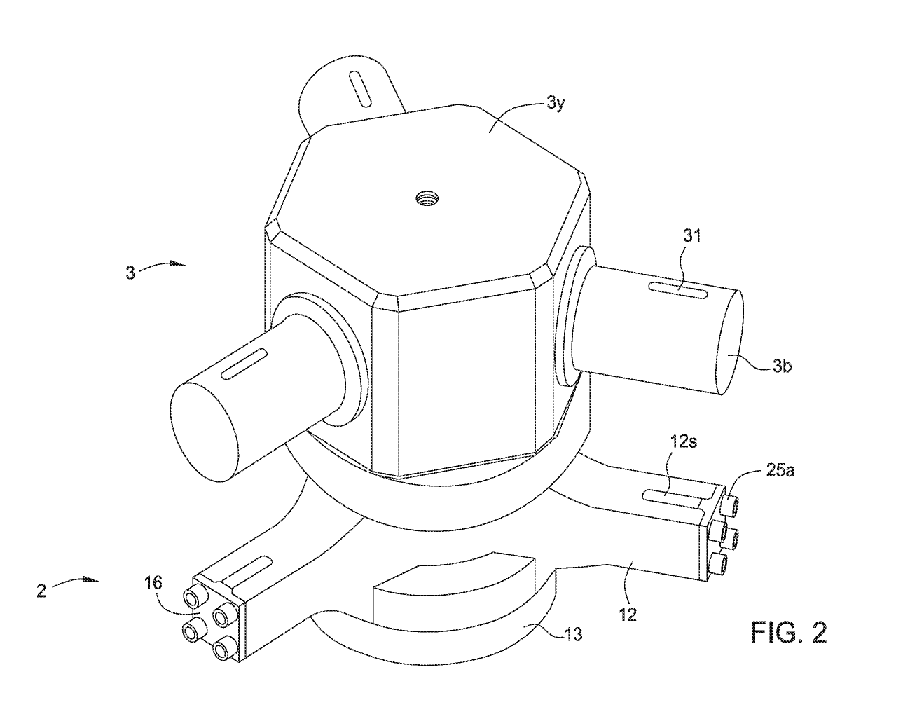

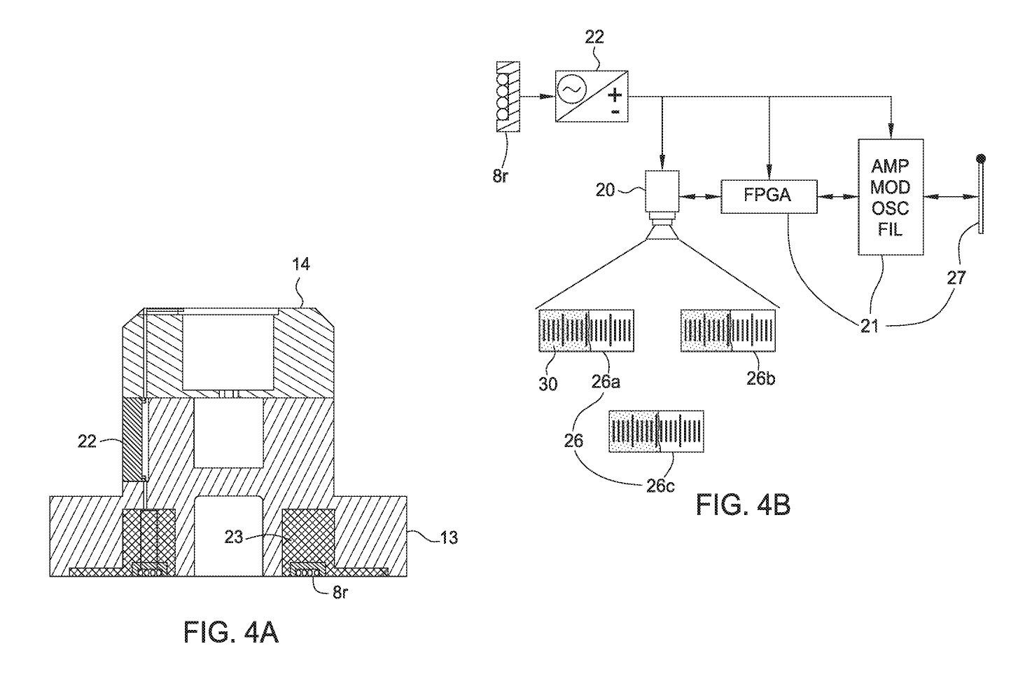

FIGS. 1 and 4B illustrate a drainage test being performed using a centrifuge 1 having an onboard imaging system 2, according to one embodiment of the present disclosure. A drainage test is a type of centrifuge test that involves spinning reservoir core samples to extract fluid from the samples. Data from the test may include images or measurements of the reservoir core samples and/or of the fluid, and such images or measurements may be made over time. FIGS. 2, 3, and 4A illustrate the centrifuge 1. As seen in FIG. 1, the centrifuge 1 may include the imaging system 2, a rotor 3, a motor 4, a motor driver 5, a housing 6, a light source 7, and a power coupling 8. A stationary computer, such as a desktop 9, which may be external to the centrifuge 1, may be in data communication with the imaging system 2 (e.g., wireless data communication with antenna 27 coaxial with the rotor 3) for processing images therefrom shot during the test. The centrifuge 1 may be powered by an electrical power source, such as a three phase alternating current source 10, in electrical communication with the motor driver 5 and the power coupling 8, such as by respective power cables. The imaging system 2, rotor 3, motor 4, motor driver 5, light source 7, and/or power coupling 8 may be disposed in the housing 6. The imaging system 2 may be torsionally connected to the rotor 3 of the motor 4, thereby spinning 11 in conjunction with the rotor 3. The imaging system 2 may also be longitudinally supported by the rotor of the motor 4.

Alternatively, the stationary computer may be a laptop, netbook, tablet, personal digital assistant, or smartphone instead of the desktop 9. Alternatively, antenna 27 may be located elsewhere on an external surface of imaging system 2 in a configuration that does not disturb the balance of centrifuge 1 (i.e., an axially symmetric configuration). Alternatively, the stationary computer may be in data communication with the imaging system 2 via electrical or optical connections through the shaft of motor 4, for example using a swivel coupling. Alternatively, the power coupling 8 may be in electrical communication with an electrical power source separate from the source 10, such as a low voltage alternating current source, or a transformer may be disposed between the source 10 and the power coupling 8 for reducing the voltage. Alternatively, the source 10 may be in electrical communication with the imaging system 2 via electrical connections through the shaft of motor 4, for example using a swivel coupling.

The motor 4 may be electric and have one or more, such as three, phases. The motor 4 may be a switched reluctance motor or a permanent magnet motor, such as a brushless direct current motor. The motor 4 may include a stator mounted to the housing 6 and a rotor disposed in the stator for being spun 11 thereby. The motor driver 5 may be mounted to the housing 6 and be in electrical communication with the stator of the motor 4 via a power cable. The power cable may include a pair of conductors for each phase of the motor 4. The motor driver 5 may be variable speed including a rectifier and an inverter. The motor driver 5 and motor 4 may be capable of turning the centrifuge at speeds between about thirty revolutions per minute (RPM) and about sixteen thousand RPM. In some embodiments, the motor driver 5 and motor 4 may be capable of speeds between about one hundred RPM and about twenty-five thousand RPM. In some embodiments, the motor driver 5 and motor 4 may be capable of speeds between about six thousand RPM and about sixteen thousand RPM. The desktop 9 may be in communication with the motor driver 5. The rectifier may convert the three phase alternating current power signal from the source 10 to a direct current power signal and the inverter may modulate the DC power signal to drive each phase of the motor stator based on speed instructions from the desktop 9. The motor driver 5 and motor 4 may be capable of high speed operation, such as greater than or equal to ten thousand RPM, twenty-five thousand RPM, one hundred and twenty thousand RPM or more.

As seen in FIG. 2, the imaging system 2 may include a relay housing 12, which may have a cylindrical hub and one or more, such as three, arms extending outward from the hub. The arms may be spaced around the hub at regular intervals, such as three at one-hundred twenty degrees. Each arm may have an optical cavity formed therein, and the optical cavity may extend into the hub. Each arm may have at its distal end a relay mirror holder 16. Each arm may also have a slot 12s formed in an upper surface thereof and adjacent to a distal end thereof for providing optical communication between the optical cavity and a respective sample holder of the rotor 3. Each arm may have a plurality of threaded sockets extending from the distal end thereof for receiving threaded shaft portions of respective threaded fasteners 25a (four shown for each arm), and each mirror holder 16 may have a plurality of holes formed therethrough for receiving the shaft portions of the threaded fasteners, thereby connecting the mirror holders 16 to the arms.

The rotor 3 may include the body 3y and one or more (three shown) sample holders. The sample holders may be spaced around the body 3y at regular intervals (matching the regular intervals of the spacing of the arms of relay housing 12), such as three at one-hundred twenty degrees (shown) or four at ninety degrees (not shown). The rotor 3 may be oriented relative to the imaging system 2 such that the sample holders are aligned with the arms of the relay housing 12. The sample holders may be torsionally connected, via the rotor 3, to the imaging system 2, spinning in conjunction with the rotor 3, and thus with the imaging system 2. The body 3y may be polygonal, have the passage formed therethrough for the light source cable/wires, and have one or more (three shown) threaded sockets formed in an outer surface thereof for receiving the sample holders. Each sample holder may include a bucket 3b, a transparent calibrated receiving tube, a sample cup for receiving a reservoir core sample 29, a support cone, a cushion, a cap, a sealing screw, and one or more seals, such as o-rings. Each bucket 3b may be cylindrical and have a threaded lug formed at an inner surface thereof for engagement with the respective threaded socket of the body 3y, thereby connecting the sample holder to the body 3y. Each bucket 3b may have a pair of aligned windows 31 formed through a wall thereof and aligned with the calibrated receiving tube for imaging thereof. Each pair of windows 31 may be aligned with the respective arm slot 12s of the relay housing 12.

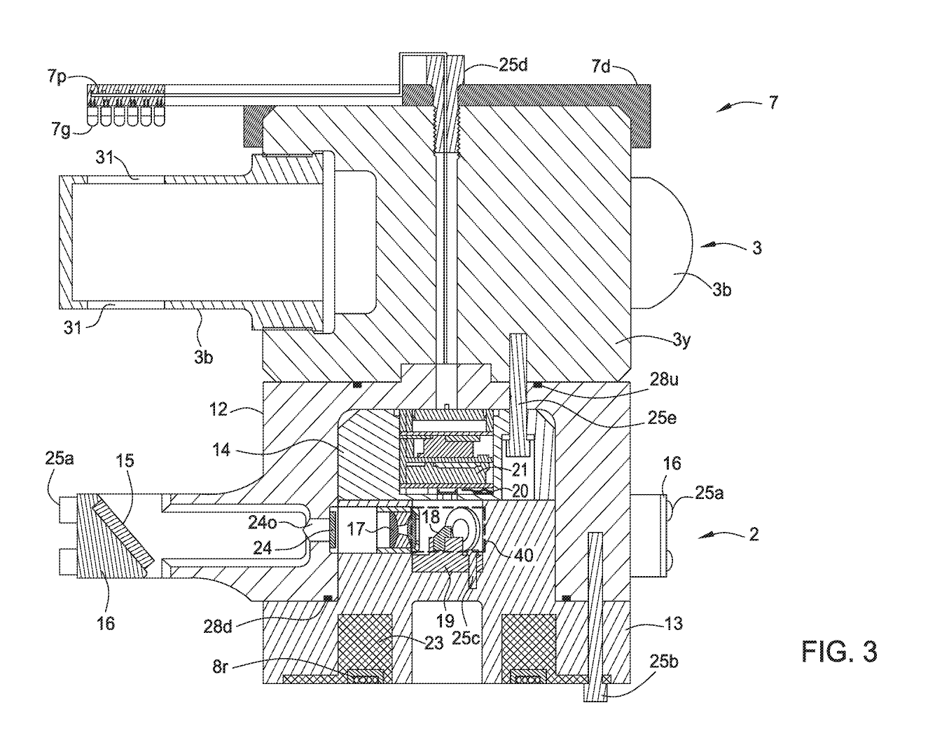

As seen in FIG. 3, the imaging system 2 may include a receiver 8r of the power coupling 8, a relay housing 12, an optics housing 13, an electronics housing 14, one or more, such as three, relay mirrors 15 disposed in respective relay housing 12 arms, a relay mirror holder 16 for each relay mirror, a camera lens 17 for each relay mirror, an array mirror 18, an array mirror mount 19, an image sensor 20, and a camera electronics package 21.

The hub of relay housing 12 may have a opening 24o for each arm formed through an inner portion thereof and providing optical communication between the respective optical cavity of the arm and the optics housing 13. Each opening 24o may be enlarged at an inner face of the hub for receiving a transparent pane 24 connected to the relay housing 12, such as by bonding. The relay housing 12 may have a chamber formed therein for receiving the optics housing 13 and the electronics housing 14. The transparent pane 24 may seal the chamber from the opening 24o and optical cavity to prevent infiltration of contaminants.

Each mirror holder 16 may have an inclined receptacle formed therein, and each relay mirror 15 may be a flat, reflective surface and received in the respective receptacle and bonded to the respective mirror holder. The mirror holder may be adjustable to allow transverse and/or angular adjustment of the mirror location and orientation. Different lengths of mirror inserts may be utilized to correspond to different test conditions, for example, changing the position of the windows 31 on the sample holder when changing from a drainage test to an imbibition test. Each relay mirror 15 may be made of a suitable, shatterproof, reflective material, for example, a metallic, material such as being made from aluminum or an alloy thereof.

The optics housing 13 may have a cylindrical body, a lower flange extending outward therefrom, a lower receptacle for receiving the rotor of the motor 4, a lower annular cavity and groove for receiving a shield 23 and the receiver 8r, an optical gallery 40 for receiving the array mirror 18 and mount 19, and an optical passage for each relay mirror 15 extending from an outer surface of the body to the optical gallery 40. The flange may have one or more (only one shown) fastener holes formed therethrough for receiving a shaft of a respective threaded fastener 25b. The optics housing 13 may have one or more (only one shown) threaded sockets formed therein adjacent to the optical gallery 40 for receiving a threaded shaft of a fastener 25c. The mount 19 may have one or more (only one shown) holes formed through a flange thereof for receiving the shaft of the fastener 25c, thereby connecting the mount 19 to the optics housing 13 with proper orientation of the array mirror 18 relative to the optical passages. The lower receptacle may have a torsional profile formed therein for engagement with a complementary torsional profile of the rotor of the motor 4.

Each camera lens 17 may be disposed in the respective optical passage and connected to the optics housing 13, such as by bonding. Each camera lens 17 may include a case, a plano-convex lens, a lens spacer, and a convex-plano lens. The lenses and spacer may be disposed in the case and connected thereto, such as by bonding. The lenses may be arranged to optimize a respective image 26a-c for capture by the image sensor 20 (see FIG. 4B).

The array mirror 18 may have an inclined reflective face for each relay mirror 15. The array mirror 18 may be made up of an array of smaller mirrors, also referred to as a segmented mirror. The array mirror 18 may also have one or more (only one shown) posts for being received by respective sockets of the mount 19, thereby ensuring proper orientation of the array mirror 18 relative to the optical passages. The array mirror 18 may also be connected to the mount 19, such as by bonding or interference fit.

The power coupling 8 may be non-contacting, such as inductive, and may serve as a local electrical power source for the imaging system 2. Each of the receiver 8r and a transmitter 8s of the power coupling 8 may include a core and a coil of wire wrapped around the core. The wire may be made from an electrically conductive material, such as copper, copper alloy, aluminum, or aluminum alloy and jacketed with a dielectric material, such as a polymer. The cores may each be made from a ferromagnetic material. The shield 23 may be a nonmagnetic and dielectric material, such as a polymer (e.g., thermoset), molded into the lower annular cavity and groove of the optics housing 13. The shield 23 may also have a hole formed through a rim thereof for receiving the shaft of the fastener. The receiver 8r may be inserted into a lower face of the shield 23 during molding, thereby bonding the rotor to the shield. A base of the shield 23 may have a sufficient thickness to prevent formation of eddy currents in the optics housing 13 during operation of the power coupling 8.

As seen in FIG. 4, a power converter 22 may be disposed in a recess formed in an outer surface of the optics housing 13. The power converter 22 may be in electrical communication with the receiver 8r via electrical wires or cable extending therebetween via a passage formed through the optics housing 13. The power converter 22 may include a rectifier and voltage regulator for converting the alternating current power signal received from the receiver 8r to a direct current power signal for use by the camera electronics package 21 and the light source 7. The power converter 22 may be secured in the recess, such as by bonding. The power converter 22 may be in electrical communication with the camera electronics package 21 via electrical wires or cable extending therebetween via a passage formed through the electronics housing 14. The camera electronics package 21 may include a power splitter for relaying the direct current power signal to the light source 7 via electrical wires or cable extending therebetween. For example, wires may connect from camera electronics package 21 to the light source 7 via a passage formed through the electronics housing 14, a passage formed through a body 3y of the rotor 3, a passage formed through a fastener 25d, and slots (only one shown) formed in a body 7d of the light source 7 (see FIG. 3). The camera electronics package 21 may supply electrical power to the image sensor 20.

Alternatively, the power coupling 8 may be capacitive instead of inductive. Alternatively, a contacting power coupling, such as slip rings or liquid metal, may be used instead of the non-contacting power coupling 8.

The electronics housing 14 may be cylindrical having a rectangular receptacle formed therein and a lower aperture formed therethrough adjacent to the receptacle. The image sensor 20 and camera electronics 21 may be disposed in the receptacle and molded therein, such as using a polymer (i.e., thermoset). The receptacle may be centrally located in the electronics housing 14 and be concentric with a rotational axis of the centrifuge for minimizing centrifugal acceleration of the image sensor 20 and camera electronics 21. The image sensor 20 may be located adjacent to the aperture and in alignment with the array mirror 18. The image sensor 20 may be a monochrome digital CMOS sensor and may include an active pixel sensor array circuit, an analog processor circuit, an analog to digital converter circuit, a timing and control circuit, and a control register circuit. The active pixel sensor array circuit may be greater than or equal to one megapixel. The circuits may be packaged in a ceramic leadless chip carrier. The image sensor 20 may include programmable parameters of gain, frame rate, frame size, exposure, contrast, acquisition rate, and/or integration time. The image sensor 20 may have a one-half inch optical format and may have an electronic rolling shutter.

Alternatively, the image sensor 20 may be CCD instead of CMOS and/or grayscale or color instead of monochrome.

The camera electronics package 21 may be arranged on one or more, such as three, stacked printed circuit boards. The image sensor 20 may also be mounted to one of the printed circuit boards. The printed circuit boards may be in electrical communication with each other via jumpers. The camera electronics package 21 may include a microcontroller circuit, such as a field-programmable gate array (FPGA), and a wireless data link, such as a radio frequency transceiver and an antenna 27. The FPGA may receive digital image data from the image sensor 20 and may process the data for transmission to the desktop 9 via the radio frequency transceiver. The radio frequency transceiver may include an amplifier (AMP), a modem (MOD), an oscillator (OSC), and a filter (FIL) for transmitting a modulated radio frequency signal to the desktop 9 and receiving command signals therefrom.

Alternatively, the microcontroller may be an application-specific integrated circuit instead of an FPGA. Alternatively, the data link may include a transmitter instead of a transceiver. Alternatively, the power coupling 8 may be used as the data link, such as broadband over power line. Alternatively, the data link may be a second inductive or capacitive coupling. Alternatively, the data link may be non-wireless, such as slip rings, liquid metal, or electrical or optical connections through the shaft of motor 4, for example using a swivel coupling. Alternatively, the data link may operate at other frequencies besides radio, such as infrared.

Referring again to FIG. 3, the electronics housing 14 may have one or more (only one shown) recesses and holes formed therethrough, each recess and hole for receiving a respective threaded fastener 25e. A shaft of each threaded fastener 25e may extend through a respective hole formed through the relay housing 12 and into a threaded socket formed in the body 3y, thereby connecting the rotor 3 to the imaging system 2 in the proper orientation. The electronics housing 14 may further have an upper seal groove formed in an upper face thereof adjacent to the rotor body 3y and a lower seal groove formed in a lower face thereof adjacent to the optics housing 13. Seals, such as o-rings 28u,d, may be disposed in the seal grooves for sealing the chamber from interfaces therebetween to prevent infiltration of contaminants. The imaging system 2, the rotor body 3y, and the light source 7 may be assembled in a sterile and dry environment such that the chamber is free from contaminants. As part of the assembly, sealant may be injected into the passage of the threaded fastener 25d to seal the interface between the wires/cable and the threaded fastener.

The light source 7 may include the body 7d and one or more (such as three) rows of lights 7g. Each row may include one or more (six shown) lights 7g. The light source 7 may further include a power bus 7p for each row and a splitter to distribute the electrical power among the rows. The body 7d may have a polygonal shape corresponding to the polygonal shape of the rotor body 3y and may rest atop the rotor body and drape over the sides thereof, thereby torsionally connecting the light source 7 to the rotor 3. Each row of lights 7g may extend across and be aligned with the respective pair of windows 31 of the respective bucket 3b. The lights 7g may each be a light emitting diode (LED) including a semiconductor die, a lead-frame, and a transparent case. The semiconductor die may be disposed in a reflective cavity carried by an anvil of the lead-frame. A wire bond may connect the semiconductor die to a post of the lead-frame. Each of the post and anvil may have a plug portion extending from the transparent case. The body 7d may have sockets receiving the plug portions for anchoring the lights 7g thereto and leads may electrically connect the plug portions to respective terminals of the power bus 7p. The body 7d may have a hole formed therethrough for receiving a shaft of the fastener 25d and an upper portion of the passage of the body 3y may be threaded for engagement with the fastener 25d, thereby connecting the light source 7 to the rotor 3.

Alternatively, the lights 7g may each be incandescent, compact fluorescent, electric arc, Hydrargyrum medium-arc iodide (HMI), high intensity discharge (HID), or quartz halogen. Alternatively, the light source 7 may be mounted to the housing 6 and may be continuously operated or strobed in synchronization with the imaging system 2. In this alternative, the light source 7 may be mounted to the housing 6 above the sample holders or below the sample holders and the relay mirror holders 16 may be transparent. Alternatively, the light source 7 may be mounted to the arms of the relay housing 12. Alternatively, the light source 7 may be mounted in or on any member of the imaging system 2.

In operation, as seen in FIG. 1, the reservoir core samples 29 may be saturated in oil 30 and loaded into the sample holders. The buckets 3b may then be screwed into the body 3y. The light source 7 may be activated and power supplied to the imaging system 2 via the power coupling 8. The motor 4 may then be activated to spin 11 the imaging system 2, rotor 3, and light source 7 at a first angular speed. Centrifugal acceleration of the reservoir core samples 29 may throw the oil 30 into the calibrated receiving tubes of the sample holders. As the reservoir core samples 29 are being spun 11, the light source 7 may illuminate the calibrated receiving tubes of the sample holders via the windows 31 of the buckets 3b for viewing the images 26a-c thereof by the relay mirrors 15. The viewed images 26a-c may be reflected by the relay mirrors 15 from a downward direction to a radial direction along the optical cavities and openings 24o of the relay housing 12, through the transparent panes 24, along the optical passages of the optics housing 13, and through the camera lenses 17 to the array mirror 18. The array mirror 18 may reflect the viewed images 26a-c from the radial direction to an upward direction and the viewed images may travel along the upward direction to the image sensor 20.

The image sensor 20 shown in FIG. 4 may capture the three images 26a-c simultaneously in a two-dimensional, such as triangular, array 26. The image sensor 20 may digitize the captured array 26 and supply the digitized array to the FPGA. The FPGA may process the digitized array for transmission and operate the transceiver and antenna 27 to modulate and transmit the digitized array to the desktop 9. The desktop 9 may receive and demodulate the digitized array and analyze the digitized array to determine liquid levels of the oil 30 in the calibrated receiving tubes of the sample holders. The desktop 9 may also display the digitized array for viewing by a technician and store the digitized array. The imaging system 2 may repeat image capture and transmission at a frequency selected by the technician and have the capability of capturing and transmitting the images at a frequency greater than or equal to once per second, such as four or five times per second, thereby providing real time viewing of the reservoir core samples 29.

Alternatively, the images 26a-c may be serially captured instead of simultaneously captured, thereby yielding higher resolution. Alternatively, the array 26 may be captured as continuous video. Alternatively, the imaging system 2 may include a plurality of image sensors 20, such as one or more for each sample holder. In a first variant of this alternative, the image sensors 20 may still be located in the receptacle of the electronics housing 14; however, the imaging system 2 may include a second set of relay mirrors to deliver each image 26a-c to the respective image sensor instead of the array mirror 18. In a second variant of this alternative, the image sensors 20 may be mounted in or on the arms of the relay housing 12. In this second variant, each image sensor 20, camera lens 17, and camera electronics package 21 may be mounted to a distal end of the respective arm instead of the respective relay mirror holder 16 and relay mirror 15. The array mirror 18 may also be omitted in this second variant. In yet another variant, a second imaging system 2′ may be located above rotor 3 to capture a second set of images 26′a-c from a different angle than the first set of images 26a-c.

If capillary pressure is being measured, the centrifuge may continue to spin 11 at the first angular speed until oil production from the reservoir core samples 29 has ceased. The final oil levels may be recorded and the motor 4 operated at a second angular speed greater than the first angular speed until oil production has ceased. The final oil levels may again be recorded and so on for ten or more increments. If relative permeability is being measured, the oil levels may be recorded as a function of time at the first speed. Once the test has concluded, the desktop 9 may process the recorded oil levels to obtain capillary pressure or relative permeability.

Alternatively, the reservoir core samples 29 may be saturated with water instead of oil.

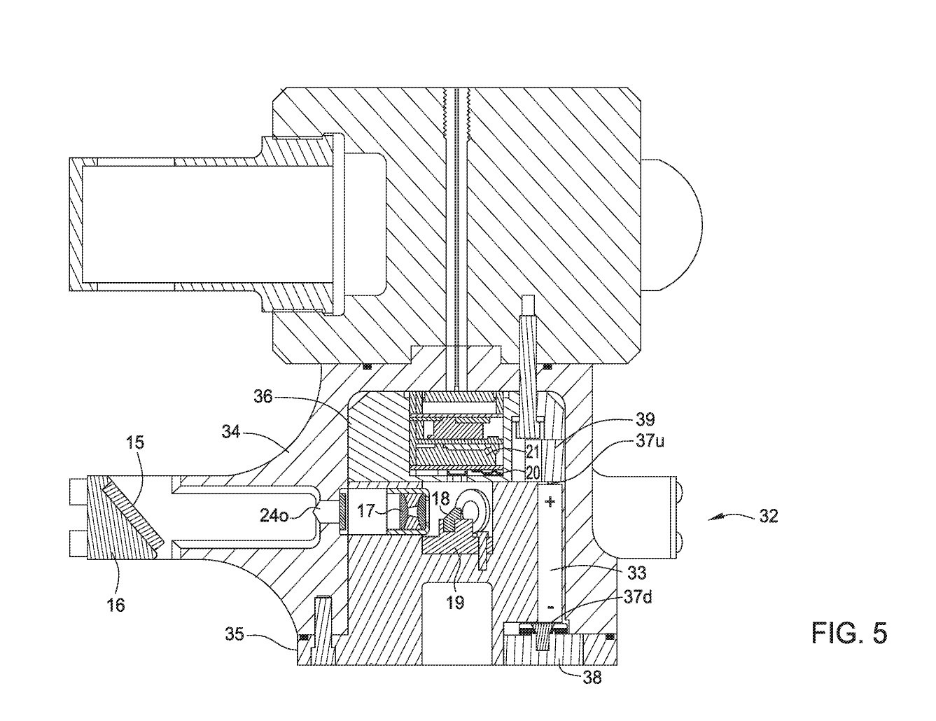

FIG. 5 illustrates an alternative imaging system having a battery 33 instead of the receiver 8r of the non-contacting power coupling 8, according to another embodiment of the present disclosure. The alternative imaging system 32 may include the battery 33, a modified relay housing 34, a modified optics housing 35, a modified electronics housing 36, the relay mirrors 15, the relay mirror holders 16, the camera lenses 17, the array mirror 18, the array mirror mount 19, the image sensor 20, the camera electronics package 21, battery contacts 37u,d, a compartment cap 38, and a contact spacer 39. The battery 33 may be disposed in a compartment formed in the modified optics housing 35. The compartment cap 38 may have a threaded outer surface for screwing into a threaded inner surface of the modified optics housing 35, thereby retaining the battery 33 in the compartment. Electrical wires or cable may connect the battery contacts 37u,d to the camera electronics package 21. The battery 33 may be stable and rechargeable, such as a lithium-ion or nickel-metal hydride battery.

Alternatively, the battery 33 may be disposable, such as an alkaline battery. Alternatively, the battery 33 may be added to the imaging system 2 as a redundant power supply in case of failure of the power coupling 8.

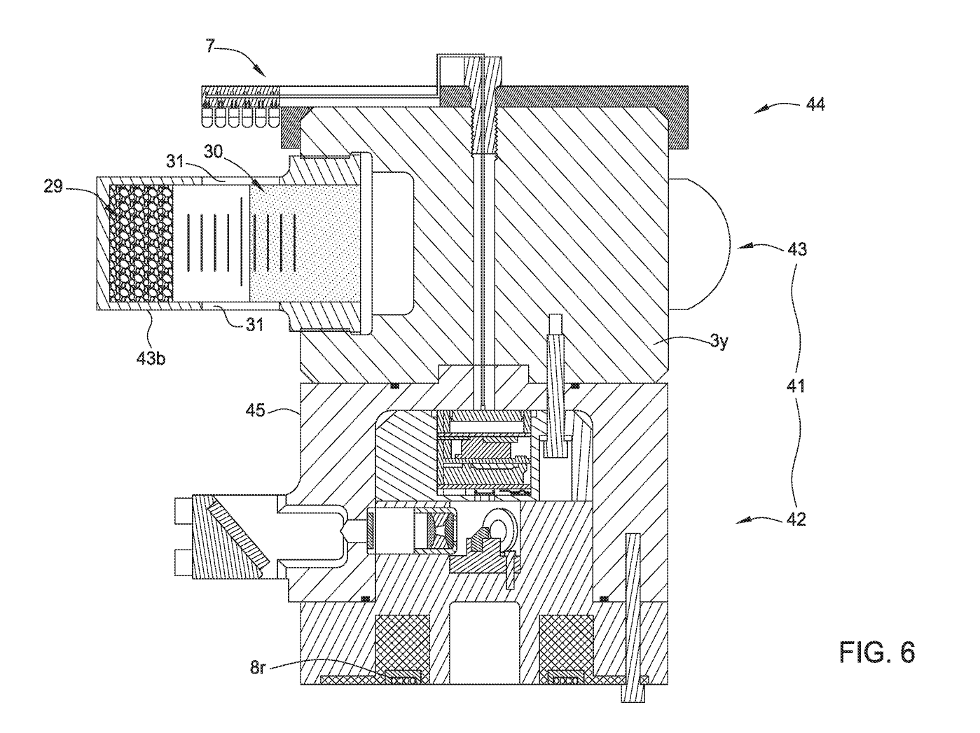

FIG. 6 illustrates an alternative centrifuge 41 for performing an imbibition test, according to another embodiment of the present disclosure. An imbibition test is a type of centrifuge test that involves spinning reservoir core samples to inject fluid into the samples. Data from the test may include images or measurements of the reservoir core samples and/or of the fluid, and such images or measurements may be made over time. The alternative centrifuge 41 may include a modified imaging system 42, a modified rotor 43, the motor 4, the motor driver 5, the housing 6, a modified light source 44, and the power coupling 8 (only receiver 8r shown).

The modified rotor 43 may include the body 3y and one or more modified sample holders. Each modified sample holder may include a modified bucket 43b, the transparent calibrated receiving tube, the sample cup for receiving the reservoir core sample 29, the support cone, the cushion, the cap, the sealing screw, and the one or more seals, such as o-rings. Each modified bucket 43b may have be cylindrical and have a threaded lug formed at an inner surface thereof for engagement with the respective threaded socket of the body 3y, thereby connecting the modified sample holder to the body 3y. Each modified bucket 43b may have a pair of aligned windows 31 formed through a wall thereof and aligned with the calibrated receiving tube of the modified sample holder for imaging thereof. Each modified bucket 43b may have the pair of windows 331 located at a proximal end, adjacent to the lug, instead of adjacent to a distal end thereof, as compared to each bucket 3b. The modified imaging system 42 may have a modified relay housing 45 with shortened arms to accommodate the modified buckets 43b.

In operation, as seen in FIG. 6, the reservoir core samples 29 may be loaded into the modified sample holders. The modified buckets 43b may then be screwed into the body 3y. The transparent calibrated receiving tubes may initially be filled with reservoir fluid, such as oil 30, and may be located inward of the of the reservoir core samples 29. Centrifugal acceleration of the calibrated receiving tubes of the modified sample holders may inject the oil 30 into the reservoir core samples 29. As the reservoir core samples 29 are being spun 11, the light source 7 may illuminate the calibrated receiving tubes via the windows 31 of the modified buckets 43b for viewing the images 26a-c thereof by the relay mirrors 15, as before.

Alternatively, the sample holders and the modified sample holders may be constructed interchangeably. For example, the calibrated receiving tube and the sample cup may be removable from the bucket, such that in a first configuration, the calibrated receiving tube may be inserted first, being disposed at the distal end of the bucket. In a second configuration, the sample cup may be inserted first, being disposed at the distal end of the bucket. Alternatively, the sample cup and calibrated receiving tube may be pivotally coupled with the bucket. The windows 31 of the bucket 3b may be located adjacent to each end of the bucket, or the windows 31 may extend from the proximal end to the distal end of the bucket 3b, providing imaging access to the calibrating receiving tubes at either end.

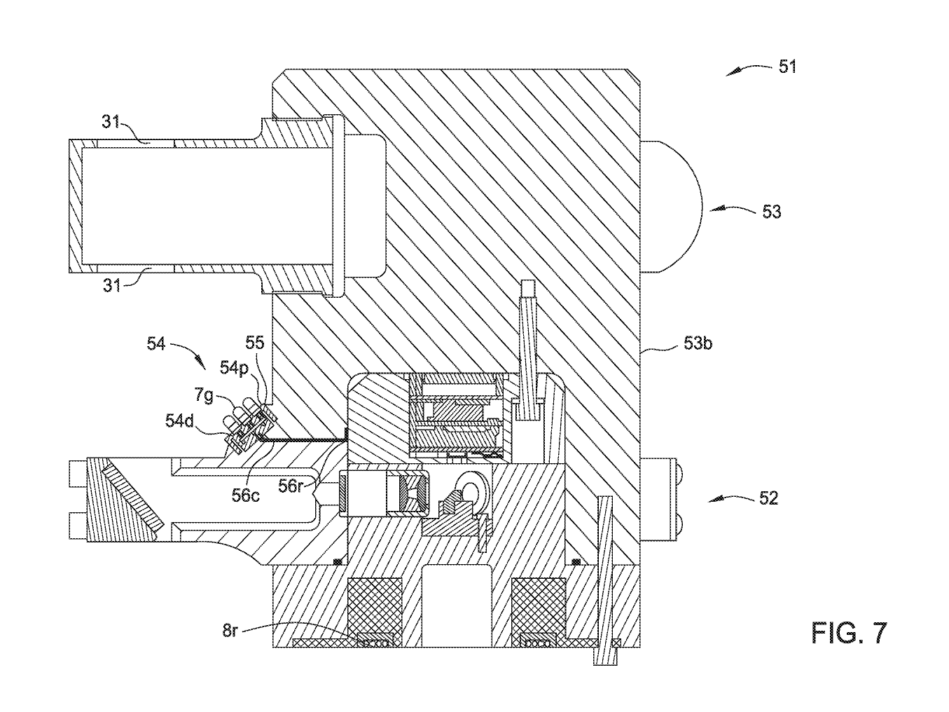

FIG. 7 illustrates a second alternative centrifuge 51, according to another embodiment of the present disclosure. The second alternative centrifuge 51 may include a modified imaging system 52, a modified rotor 53, the motor 4, the motor driver 5, the housing 6, a modified light source 54, and the power coupling 8 (only receiver 8r shown). The second alternative centrifuge 51 may include a rotor body 53b being a combination of the rotor body 3b and the relay housing 12.

The modified light source 54 may include one or more, such as three, bodies 54d (only one shown) and each body may have a row of lights. Each row may include one or more (three shown) lights 7g. Each body 54d may include a power bus 54p to distribute the electrical power among the row of lights 7g. The rotor body 53b may have a receptacle formed adjacent each arm thereof for receiving a respective body 54d. Each body 54d of the modified light source 54 may have a flange for being mounted in the receptacle by one or more (pair shown) threaded fasteners 55, thereby torsionally connecting the modified light source 54 to the rotor body 53b. Each row of lights 7g may be aimed at the lower window 31 of the respective bucket 3b by being inclined at an acute angle relative to a longitudinal axis of the bucket that illuminates the calibrated receiving tube thereof. The mounting of the modified light source 54 below and with inclination may prevent blooming of the images 26a-c from direct illumination and mitigate optical aberrations due to light passing through the sample holders with materials of different refractive indexes and curvature.

Each receptacle of the rotor body 53b may have an electrical socket and each body 54d of the modified light source 54 may have a mating electrical plug extending from a bottom thereof and in electrical communication with the power bus 54p. An electric cable 56c may extend from the respective electrical socket along a passage formed through a wall of the rotor body 53b to a pair of electrical contact rings 56r. The electrical contact rings may be mounted in respective grooves formed in an inner surface of the rotor body 53b and be engaged with contacts of a modified power converter of the modified imaging system 52, thereby providing electrical power to the modified light source 54.

Alternatively, the modified centrifuge 51 may have a separate rotor body and relay housing.

Alternatively, either centrifuge 1, 51 may be used to perform an imbibition test.

Alternatively, any of the centrifuges 1, 41, 51 may be used for any other type of test for measuring static and/or dynamic fluid and/or rock properties of the reservoir core samples 29, such as overburden stress, besides capillary pressure and relative permeability. Alternatively, any of the centrifuges 1, 41, 51 may be adapted for other industries, such as mining and/or civil engineering use. Alternatively, any of the centrifuges 1, 41, 51 may be capable of running refrigerated or heated tests instead of tests discussed above at room temperature. Alternatively, any of the centrifuges 1, 41, 51 may be capable of operating in a vacuum or low pressure chamber.

A centrifuge, comprising: a motor having a rotor; an imaging system torsionally connected to the rotor; a sample holder torsionally connected to the imaging system; and a light source for illuminating the sample holder, wherein the imaging system includes: a image sensor in optical communication with the sample holder; and a data link for transmitting image data.

A centrifuge, further comprising an electrical power source in communication with the image sensor and the data link.

A centrifuge, wherein: the centrifuge comprises a plurality of the sample holders, and the imaging system further includes: a relay housing having a hub and a plurality of arms extending from the hub, each arm aligned with the respective sample holder; and a plurality of relay mirrors, each relay mirror for reflecting an image of the respective sample holder from a first vertical direction to a radial direction along an optical cavity of the respective arm.

A centrifuge, wherein at least one of the plurality of relay mirrors is a flat, reflective surface, comprising a shatterproof, reflective material.

A centrifuge wherein the imaging system further includes: an optics housing having an optical gallery and a plurality of optical passages extending from an outer surface thereof to the optical gallery; and a plurality of camera lenses, each camera lens disposed in a respective optical passage.

A centrifuge, wherein: the hub has an opening for each arm providing optical communication between the respective cavity and the optical gallery, and the imaging system further includes a plurality of transparent panes, each pane sealing a respective opening.

A centrifuge, wherein the camera lens comprises a plano-convex lens and a convex-plano lens.

A centrifuge, wherein: the imaging system further includes an array mirror having a reflective face for each relay mirror and for reflecting the images from the radial direction to a second vertical direction, and the image sensor is in alignment with the array mirror for receiving the images therefrom.

A centrifuge, wherein the image sensor is operable to capture the images of the respective sample holders simultaneously.

A centrifuge, wherein the data link is wireless.

A centrifuge, wherein the data link transmits the image data from the image sensor to a stationary computer.

A centrifuge, wherein the data link comprises an antenna coaxial with the rotor.

A centrifuge, wherein the data link comprises an electrical connection through a shaft of the motor.

A centrifuge, wherein the data link further comprises a swivel coupling.

A centrifuge, wherein the electrical power source is a non-contacting coupling.

A centrifuge, wherein the electrical power source is in communication with the image sensor and the data link via electrical connections through a shaft of the motor.

A centrifuge, wherein: the imaging system further includes a nonmagnetic and dielectric shield, and a receiver of the non-contacting coupling is disposed in the shield.

A centrifuge, wherein the imaging system further includes a power converter for rectifying and regulating an alternating current power signal from the receiver and supplying a direct current power signal to the image sensor and the wireless data link.

A centrifuge, wherein the electrical power source is a battery.

A centrifuge, wherein the light source is torsionally connected to the imaging system above the sample holder.

A centrifuge, wherein the light source is torsionally connected to the imaging system below the sample holder.

A centrifuge, wherein the light source arranged at an acute angle relative to a longitudinal axis of the sample holder.

A centrifuge, wherein the image sensor is concentrically located relative to a rotational axis of the centrifuge.

A centrifuge, further comprising a rotor body torsionally connecting the sample holder to the imaging system.

A centrifuge, wherein: the sample holder comprises a bucket for receiving a reservoir core sample, and the bucket has a pair of aligned windows formed therethrough.

A centrifuge, wherein the windows are located adjacent to distal end of the bucket for conducting a drainage test.

A centrifuge, wherein the windows are located adjacent to proximal end of the bucket for conducting an imbibition test.

A centrifuge, wherein the imaging system further includes: a relay housing having a hub and an arm extending from the hub, the arm aligned with the sample holder; and a relay mirror on a mirror holder, the relay mirror for reflecting an image of the sample holder from a first vertical direction to a radial direction along an optical cavity of the arm; the mirror holder is adjustable to locate the relay mirror at either a distal or a proximal end of the arm; and the windows are located both adjacent to a proximal end of the bucket and adjacent to a distal end of the bucket.

A centrifuge, wherein the imaging system is located below the sample holder, the centrifuge further comprising a second imaging system located above the sample holder.

A method of conducting a centrifuge test, comprising: spinning a reservoir core sample in a sample holder of a rotor, wherein an imaging system is torsionally connected to the rotor; and collecting image data of the sample holder with the imaging system while spinning.

A method, wherein the collecting image data comprises: illuminating the sample holder with a light source; capturing an image of the illuminated sample holder with an image sensor of the imaging system; and digitizing the image.

A method, wherein the capturing the image comprises reflecting the image of the illuminated sample holder by at least one relay mirror.

A method, wherein the reservoir core sample and the relay mirror spin in conjunction with the rotor.

A method, wherein the light source also spins in conjunction with the rotor.

A method further comprising transmitting the image data to a stationary computer.

A method further comprising powering the image sensor with a stationary electrical power source.

A method wherein spinning the sample holder extracts fluid from the reservoir core sample.

A method wherein spinning the sample holder causes fluid to be injected into the reservoir core sample.

A method, wherein the spinning comprises at least six thousand revolutions per minute.

A method, wherein the centrifuge test is conducted in a low pressure chamber.

While the foregoing is directed to embodiments of the present disclosure, other and further embodiments of the disclosure may be devised without departing from the basic scope thereof, and the scope of the invention is determined by the claims that follow.

1. A centrifuge, comprising:
a motor having a rotor;
an imaging system torsionally connected to the rotor;
a sample holder torsionally connected to the imaging system; and
a light source for illuminating the sample holder,
wherein the imaging system includes:
a image sensor in optical communication with the sample holder; and
a data link for transmitting image data.

2. The centrifuge of claim 1, further comprising an electrical power source in communication with the image sensor and the data link.

3. The centrifuge of claim 1, wherein:
the centrifuge comprises a plurality of the sample holders, and
the imaging system further includes:
a relay housing having a hub and a plurality of arms extending from the hub, each arm aligned with the respective sample holder; and
a plurality of relay mirrors, each relay mirror for reflecting an image of the respective sample holder from a first vertical direction to a radial direction along an optical cavity of the respective arm.

4. The centrifuge of claim 3, wherein the image sensor is operable to capture the images of the respective sample holders simultaneously.

5. The centrifuge of claim 1, wherein the data link is wireless.

6. The centrifuge of claim 1, wherein the data link transmits the image data from the image sensor to a stationary computer.

7. The centrifuge of claim 1, wherein the data link comprises an antenna coaxial with the rotor.

8. The centrifuge of claim 1, wherein the data link comprises an electrical connection through a shaft of the motor.

9. The centrifuge of claim 8, wherein the data link further comprises a swivel coupling.

10. The centrifuge of claim 2, wherein the electrical power source is a non-contacting coupling.

11. The centrifuge of claim 2, wherein the electrical power source is in communication with the image sensor and the data link via electrical connections through a shaft of the motor.

12. The centrifuge of claim 2, wherein the electrical power source is a battery.

13. The centrifuge of claim 1, wherein the light source is torsionally connected to the imaging system above the sample holder.

14. The centrifuge of claim 1, wherein the light source is torsionally connected to the imaging system below the sample holder.

15. The centrifuge of claim 14, wherein the light source arranged at an acute angle relative to a longitudinal axis of the sample holder.

16. The centrifuge of claim 1, further comprising a rotor body torsionally connecting the sample holder to the imaging system.

17. The centrifuge of claim 1, wherein:
the sample holder comprises a bucket for receiving a reservoir core sample, and
the bucket has a pair of aligned windows formed therethrough.

18. The centrifuge of claim 17, wherein the windows are located adjacent to distal end of the bucket for conducting a drainage test.

19. The centrifuge of claim 17, wherein the windows are located adjacent to proximal end of the bucket for conducting an imbibition test.

20. The centrifuge of claim 17, wherein
the imaging system further includes:
a relay housing having a hub and an arm extending from the hub, the arm aligned with the sample holder; and
a relay mirror on a mirror holder, the relay mirror for reflecting an image of the sample holder from a first vertical direction to a radial direction along an optical cavity of the arm;
the mirror holder is adjustable to locate the relay mirror at either a distal or a proximal end of the arm; and
the windows are located both adjacent to a proximal end of the bucket and adjacent to a distal end of the bucket.

21. The centrifuge of claim 1, wherein the imaging system is located below the sample holder, the centrifuge further comprising a second imaging system located above the sample holder.

22. A method of conducting a centrifuge test, comprising:
spinning a reservoir core sample in a sample holder of a rotor, wherein an imaging system is torsionally connected to the rotor; and
collecting image data of the sample holder with the imaging system while spinning.

23. The method of claim 22, wherein the collecting image data comprises:
illuminating the sample holder with a light source;
capturing an image of the illuminated sample holder with an image sensor of the imaging system; and
digitizing the image.

24. The method of claim 23, wherein the capturing the image comprises reflecting the image of the illuminated sample holder by at least one relay mirror.

25. The method of claim 24, wherein the reservoir core sample and the relay mirror spin in conjunction with the rotor.

26. The method of claim 25, wherein the light source also spins in conjunction with the rotor.

27. The method of claim 22 further comprising transmitting the image data to a stationary computer.

28. The method of claim 23 further comprising powering the image sensor with a stationary electrical power source.

29. The method of claim 22 wherein spinning the sample holder extracts fluid from the reservoir core sample.

30. The method of claim 22 wherein spinning the sample holder causes fluid to be injected into the reservoir core sample.

31. The method of claim 22, wherein the spinning comprises at least six thousand revolutions per minute.

32. The method of claim 30, wherein the centrifuge test is conducted in a low pressure chamber.
